(19) United States
(12) Patent Application Publication
(10) Pub. No.: US 2007/0080179 A1
(43) Pub. Date: Apr. 12, 2007

(54) Metering unit for metering a substrate

(76) Inventors: Thomas Brinz, Bissingen A.D. Teck (DE); Jane Lewis, Wales (GB); Markus Tiefenbacher, Fellbach-Schmiden (DE); Thomas Geiger, Walddorfhaeslach (DE)

Correspondence Address: KENYON & KENYON LLP, ONE BROADWAY, NEW YORK, NY, 10004, US

(21) Appl. No.: 11/541,177

(22) Filed: Sep. 29, 2006

(30) Foreign Application Priority Data
Sep. 29, 2005 (DE) 10 2005 046 627.3

(51) Int. Cl. G01F 11/20

(52) U.S. Cl. 222/412

(57) ABSTRACT

A metering unit for metering a substance, in particular a powder, comprising a storage container for storing the substance and a metering device rotatable about an axis of rotation, a discharge opening being provided for discharging the metered substance, is described as fulfilling higher demands of metering accuracy in comparison with the related art. This is achieved by the fact that at least one closing element is provided on the lowest end section of the metering device for completely closing the discharge opening.

### FIELD OF THE INVENTION

The present invention relates to a metering unit for metering a substrate, in particular a powder

### BACKGROUND INFORMATION

It is often necessary in combinatorial chemistry to meter many different samples of a wide variety of types. For example, approximately 100 different samples are used for one experiment. This requires the most automated possible metering with a high measurement accuracy of the quantities to be metered. These are generally very small quantities, which demand a particularly high metering accuracy.

For example, devices having a metering unit, i.e., powder metering devices, are known from WO 02/29371 A1 and WO 02/090896 A2, in which powders, i.e., substrates, may be metered accordingly from a storage container using a rotating metering unit, in particular a metering screw.

With these metering devices, the storage container situated above the metering screw is more or less closed by the metering screw. However, it is a disadvantage here that a screw does not achieve complete closure of a corresponding metering opening, so that with such metering devices, powder, i.e., substrate, trickles through after the metering screw has rotated, i.e., at the moment when it stops after metering, i.e., after rotation of the spindle, so that metering of a very precisely defined quantity is possible only to a limited extent.

### SUMMARY OF THE INVENTION

In contrast, the object of the present invention is to propose a metering unit for metering a substance, in particular a powder, having a storage container for storing the substance and a rotating device rotatable about an axis of rotation, a discharge opening being provided for discharging the substance to be metered. This metering unit meets higher standards with regard to metering accuracy in comparison with the related art.

Accordingly, a metering device according to the present invention is characterized in that at least one closing element is provided for completely closing the discharge opening at the lowest end section of the metering device. This is an elegant method for completely preventing unintentional trickling of the substance after the metering operation, i.e., after rotation of the rotatable metering device. Accordingly, the metering accuracy is increased, which is particularly important in an application in combinatorial chemistry.

It has obviously so far been regarded as sufficient in the related art that the metering screw, which is designed to be comparatively small, and the associated relatively small cross section connected to the screw, in particular the free cross section of the metering system, results, when metering powder in particular, in the powder more or less forming lumps in the metering channel of the screw and therefore potentially stopping the metering operation. This may be adequate in the case of substrates that do not require precision metering, but much more accurate measurement of the quantity to be metered is feasible according to the present invention.

In a special variant of the present invention, the rotatable metering device, which is implemented as a metering screw or the like in particular, is designed in such a way that the axis of rotation is oriented essentially vertically. A particularly simple arrangement and/or alignment of the metering device and advantageous discharging of the substance to be metered are thus implementable in this way.

An adjustment zone of the closing element longitudinally in the direction of the axis of rotation is advantageously formed here. It has been found that such an adjustment of the closing element is particularly advantageous and/or that particularly rapid and/or effective closing of the discharge opening may be implemented. The accuracy of the metering operation is further improved accordingly.

In a preferred embodiment of the present invention, a mechanically rigid coupling is provided between the metering device and the closing element. With the help of this measure, the closing operation may be controlled accurately. For example, a particularly rapid adjustment of the closing element for closing the discharge opening may also be achieved without resulting in any slippage, e.g., between the metering device and the closing element. This measure also improves the closing of the discharge opening, i.e., of the storage container, which results in a further improvement in the metering operation.

For example, the closing element may be a separate element. If necessary, a metering screw may be provided as an essential component of the metering device and a separate closing element may also be provided in addition. In this way, for example, conveyance, i.e., metering, of the substance from the storage container may be decoupled from the closing and opening operations of the discharge container and/or the storage. This may be particularly advantageous in special applications.

In a preferred variant of the present invention, the closing element is an element of the metering device. This permits a mechanically rigid coupling between the metering device and the closing element without any great effort in an elegant manner. For example, the closing element may be fixedly attached directly to the metering device, e.g., by screwing, welding, riveting, gluing, etc. In a special refinement of the present invention, the closing element is designed in one piece with the metering device, in particular the metering screw.

The metering device advantageously includes an adjusting element for rotating the metering device and for adjusting the closing element. For example, with the help of a single adjusting element, the substance from the storage container is metered and at the same time the discharge opening may be effectively closed or opened by the same adjusting element. This significantly simplifies the design and handling, in particular for use in combinatorial chemistry. For example, it is possible to engage the adjusting element by using a handling system or the like and thereby accomplish the rotation of the metering device as well as the adjustment and/or opening and closing of the closing element.

The metering device preferably has at least one spindle or metering screw. This permits particularly effective and accurate metering of powders or the like as a substrate. For example, it is possible to accurately adjust the quantity metered per unit of time, based on the angular velocity of the metering device, i.e., the spindle, without any great effort.

With the help of a spindle, i.e., metering screw, as a metering device, comparatively large throughputs, i.e., metered quantities per unit of time, may be achieved in particular. This also improves the use of the metering unit according to the present invention in combinatorial chemistry.

The closing element is preferably situated on the end section of the spindle. It has been found that in such a variant, a particularly low design complexity is possible and particularly accurate closing and thus metering are possible, with subsequent trickle of the substrate and/or powder in particular being effectively prevented. A form-fitting closure on the metering unit and/or the discharge unit is preferably achieved via the closing element.

The shaft of the metering device and/or the spindle is advantageously designed as the adjusting element of the closing element. The design complexity is further reduced with the help of this method. Furthermore, the handling, i.e., metering, of the substrate is improved. In an advantageous variant of the present invention, at least one resetting element is provided for resetting the closing element and closing the discharge opening in a resting phase. Such a resetting element, including a spring in particular, ensures that in the resting state and/or in the unactivated state and/or in a currentless state, for example, the metering unit is effectively and securely closed. This prevents unintentional escape of the substrate through the discharge opening in this phase.

The adjusting element is preferably designed as a drivable drive element of a handling system for automated metering. This further improves the automated metering of the substrate, which is advantageous in particular in combinatorial chemistry or the like. For example, the handling system grip engages the adjusting element via a corresponding adjusted element and thereby triggers the metering while also triggering the adjustment of the closing element and/or the opening of the discharge opening.

In a special refinement of the present invention, the metering unit is designed as a replaceable module of a handling system for automated metering. For example, in an application in combinatorial chemistry or the like, the replaceable module is provided for holding a special substance and at the same time a metering unit and/or another replaceable module is assigned to each of the desired different substances and is kept on hand, e.g., in an appropriate location and/or in a storage area. The handling system grips a replaceable module, e.g., in specific experiments, meters the corresponding substance into the container provided for it and/or at the intended site, resets the replaceable module and grips a next replaceable module having another substance and so forth. This allows much more efficient implementation in combinatorial chemistry in particular with approximately 100 different substances per experiment, for example.

### BRIEF DESCRIPTION OF THE DRAWINGS

FIG. 1 shows a schematic diagram of a metering unit according to the present invention as a replaceable module in a closed state.

FIG. 2 shows a schematic diagram of the metering unit in an opened state.

### DETAILED DESCRIPTION

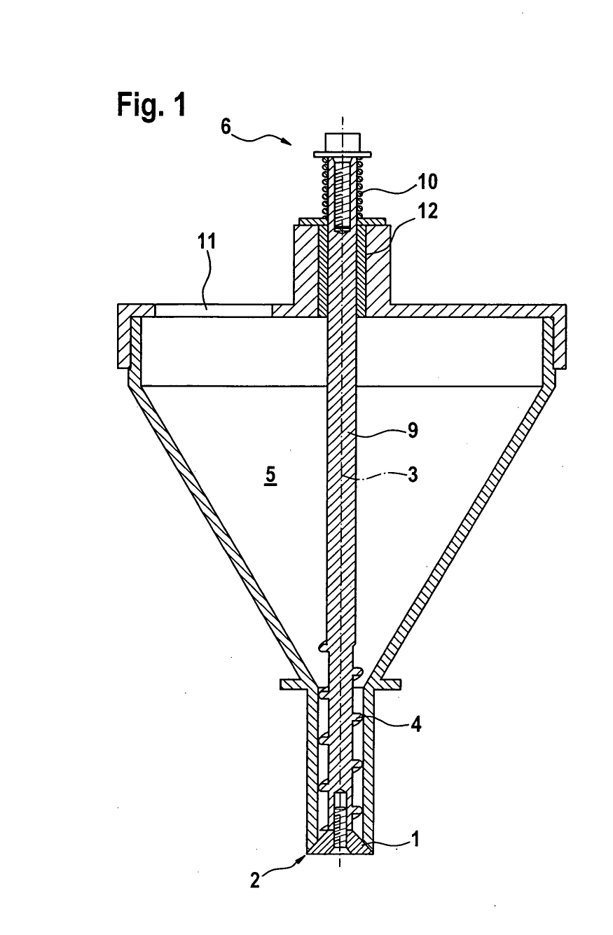

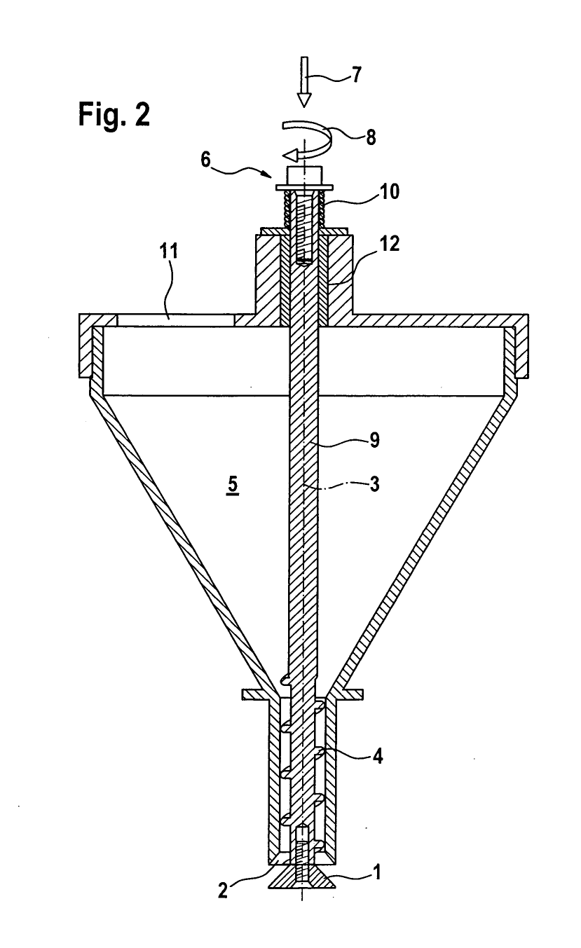

FIGS. 1 and 2 show schematically a metering unit according to the present invention. FIG. 1 shows the closed state, where a closure 1 reliably closes a discharge opening 2.

FIG. 2 shows closure 1 being adjusted axially along an axis of rotation 3 of a metering screw. Discharge opening 2 is therefore open, so that a substrate (not shown here) which may be provided in a storage container 5 may flow or trickle out through discharge opening 2.

A comparison of the two figures shows that closure 1 is adjusted along axis of rotation 3 by the fact that at the upper end, screw 1 has an adjusting element 6 and/or an adjusting area 6 which is adjustable downward via the handling system (not shown) or the like along axis of rotation 3 for opening it (see arrow 7).

In addition, adjusting element 6 may also be set in rotation according to an arrow 8 via the handling system (not shown) or the like, so metering screw 4 is able to effectively, i.e., definitively, convey substrate out of storage container 5.

Without showing the details, in a special variant of the present invention, a shaft 9 in the area of the storage container may have an element which, for example, prevents the powder stored in storage container 5 from forming lumps. For example, it might have a scraper, screw and/or spindle having a comparatively large cross section and/or a variable cross section. For example, such an element could advantageously be adapted to the cross section of storage container 5. In other words, it might have a larger diameter in the upper area and a smaller diameter in the lower area, for example.

In addition, the metering unit according to the figures has a resetting spring 10 which is intended for automatic adjustment of shaft 9 and/or closing element 1 along the axis of rotation in the unactivated state, i.e., in the resting phase, so that closing element 1 reliably closes discharge opening 2. In addition, a filling port 11 through which the substrate (not shown) may be added to storage container 5, for example, is provided. Furthermore, the metering unit has an advantageous bearing 12 by which shaft 9 and/or screw 14 may be advantageously supported.

In general, it is advantageous that the metering unit according to the present invention has a comparatively simple design and is easily adapted to a wide variety of volumes. Furthermore, trickling of substrate, in particular powder, after metering is effectively prevented by the metering unit according to the present invention because a form-fitting closure on the powder container is achieved in particular.

It is a great advantage that only one moving part, i.e., one adjusting element 6, is required for metering and closing the metering unit and the container is always reliably closed in the non-loaded state.

A particularly advantageous use of the metering unit according to the present invention is in high-throughput research, where it is often necessary to have reproducible metered addition of a wide variety of powders without any cleaning effort. For example, one metering unit according to the present invention is used per substrate and/or per powder, so the metering unit need not be cleaned after the metering operation and may be used repeatedly for metering the corresponding powder, for example.

Storage container 5 is advantageously designed to have a storage volume with which multiple metering operations may be performed. In other words, its storage volume corresponds to a multiple of the metering volume.

The metering unit according to the present invention is advantageously used at the same time as a powder supply container and may be driven manually and/or by an advantageous handling system. The metering units may be changed rapidly, so a high throughput is feasible using a unit designed as a replaceable module.

For example, multiple metering units according to the present invention may be filled in a suitable rack, each metering unit holding a supply of substrate, i.e., powder. A certain powder container, i.e., metering unit, is approached, gripped, and inserted into the metering device by a handling system. The metering unit starts by rotation of spindle 4 in the metering container in the metering unit and opening the outlet opening via a spindle stroke. Metering is performed gravimetrically into a container, conveyor belt or the like, which is situated on scales. The metered weight is measured and reported via a closed control loop via the metering device. As an alternative, the metering unit may also include scales, in which case it is determined how much substrate is “lost” in metering (subtraction weighing).

Once the target weight has been reached, the metering vessel, i.e., the metering unit, is closed again and placed back in the rack by the handling system.

The metering vessel, i.e., the metering unit, is always reliably closed via resetting spring 10 in the idle state. The metering device advantageously opens the metering unit by applying force against the spring force, for example, and the powder, i.e., substrate, is conveyed through screw 4.

In the event of possible bridging of the substrate, i.e., the powder, which might prevent the substrate from sliding up to the conveyor screw, i.e., metering screw 4, the substrate may be conveyed to screw 4 by a vibration unit or, as described above, by using a scraper element, another spindle, or the like. For example, a vibration is applied to the metering unit via the vibration element, i.e., vibration unit, so the substrate slides, i.e., is conveyed, toward screw 4 in an advantageous manner. For example, the scraper elements or the like may have different geometries in the interior of storage container 5, so they convey the substrate toward screw 4 and/or loosen the substrate to effectively prevent lumping.

What is claimed is:

1. A metering unit for metering a substance, comprising:
a storage container for storing the substance;
a metering device rotatable about an axis of rotation, the metering device including a discharge opening for discharging the substance to be metered; and
at least one closing element provided on a lowest end section of the metering device and for completely closing the discharge opening.

2. The metering unit as recited in claim 1, wherein an adjusting zone of the at least one closing element is provided longitudinally in a direction of the axis of rotation.

3. The metering unit as recited in claim 1, further comprising:
a mechanically rigid coupling between the metering device and the at least one closing element.

4. The metering unit as recited in claim 1, wherein the at least one closing element is an element of the metering device.

5. The metering unit as recited in claim 1, wherein the metering device includes an adjusting element for rotating the metering device and for adjusting the closing element.

6. The metering unit as recited in claim 1, wherein the metering device includes at least one spindle.

7. The metering unit as recited in claim 7, wherein the at least one closing element is situated on an end section of the at least one spindle.

8. The metering unit as recited in claim 7, wherein at least one of a shaft of the metering device and the spindle is an adjusting element of the at least one closing element.

9. The metering unit as recited in claim 1, further comprising:
at least one resetting element for resetting the at least one closing element and closing the discharge opening in a resting phase.

10. The metering unit as recited in claim 1, wherein the resetting unit includes at least one spring.

11. The metering unit as recited in claim 5, wherein the adjusting element includes a drivable drive element of a handling system for automated metering.

12. The metering unit as recited in claim 1, wherein the metering unit is designed as a replaceable module of a handling system for automated metering.

13. The metering unit as recited in claim 1, wherein the substance includes a powder.
